(19) United States
(12) Patent Application Publication
(10) Pub. No.: US 2012/0089680 A1
(43) Pub. Date: Apr. 12, 2012

(54) COMMUNICATION APPARATUS, COMMUNICATION SYSTEM AND SESSION CONTROL METHOD

(75) Inventors: Ryutaro Ono, Tokyo (JP); Naoyuki Mochida, Tokyo (JP)

(73) Assignee: PANASONIC CORPORATION, Osaka (JP)

(21) Appl. No.: 13/378,138

(22) PCT Filed: Jun. 29, 2010
(86) PCT No.: PCT/JP10/04298

§ 371 Date: Dec. 14, 2011

(30) Foreign Application Priority Data
Jun. 30, 2009 (JP) 2009-155291

(51) Int. Cl. G06F 15/16

(52) U.S. Cl. 709/204

(57) ABSTRACT

A communication apparatus controls a session with respect to at least one other communication apparatus by using a basic method or a reply of a call control protocol. The communication apparatus includes a message receiving section that receives a message which is transmitted from the other communication apparatus, and the message in which reconnection control information related to an operation after an end of the session is described in the basic method or the reply, and a first controlling section that performs a reconnection control based on the reconnection control information contained in the message.

### TECHNICAL FIELD

The present invention relates to a communication apparatus, a communication system, and a session control method which easily realize a transfer service, an endpoint number change service, or a conference server transition service, and which perform a multi-party call.

### BACKGROUND ART

Recently, in addition to point-to-point communication which is typified by a telephone or a video phone, multi-point communication that realizes an audio conference or multi-point video conference in which three or more parties can participate has been put to practical use. Services employing multi-point communication include audio or video communication service and the following additional services. For example, the additional services are a service of transferring a two-party call to a third party, an end point number change service in which a two-party call is switched to a three-party call or a three-party call is switched to a two-party call, a conference server transition service in which the used conference server is changed, etc. As a method of providing such a service, there is the transfer method, endpoint number change method, or conference server transition method which is compliant with the SIP (Session Initiation Protocol).

FIG. 17 is a view showing an example of the network configuration of a telephone service system compliant with the SIP. In the system shown in FIG. 17, IP telephones 801 to 804 and conference server 810 which support extension methods such as “REFER”, “NOTIFY”, and the like defined in the SIP are connected to one another through a network 800. In such a system, in the case where the IP telephones 801 to 804 perform a two-party call, the IP telephones can communicate with each other without going through the conference server 810. In the case where the IP telephones 801 to 804 perform a call among three or more parties, the IP telephones can communicate with each other with going through the conference server 810.

In the system shown in FIG. 17, a transfer to the third party during a two-party call is performed in the following procedure. First, during a call between the IP telephone 801 and the IP telephone 802, the IP telephone 801 puts the call on hold. Then, the IP telephone 801 transmits to the IP telephone 803 to set a call state with the IP telephone 803. When the IP telephone 801 thereafter executes a transfer to the IP telephone 803, a new call is established between the IP telephone 802 and the IP telephone 803. When the call between the IP telephone 801 and the IP telephone 802, and that between the IP telephone 801 and the IP telephone 803 are then cut off, the transfer is completed.

The SIP sequence in the case where the above-described transfer is performed will be described with reference to FIG. 18. FIG. 18 is a view showing an example of the transfer sequence in a telephone service compliant with the SIP. First, the IP telephone 801 sends an “INVITE” request to the IP telephone 802. In response to this “INVITE” request, the IP telephone 802 sends a “200 OK” replay to the IP telephone 801. As a result, “Call A” is established between the IP telephone 801 and the IP telephone 802.

When a holding operation is performed on the IP telephone 801 in the state where the Call A is established, the IP telephone 801 sends an “UPDATE” request to the IP telephone 802. In response to this “UPDATE” request, the IP telephone 802 sends a “200 OK” replay to the IP telephone 801. As a result, the Call A between the IP telephone 801 and the IP telephone 802 is put on hold.

Next, when an operation of calling the IP telephone 803 is performed on the IP telephone 801, the IP telephone 801 sends an “INVITE” request to the IP telephone 803. In response to this “INVITE” request, the IP telephone 803 sends a “200 OK” replay to the IP telephone 801. As a result, “Call B” is established between the IP telephone 801 and the IP telephone 803.

When a transferring operation is performed on the IP telephone 801 in the state where the Call B is established, the IP telephone 801 performs the following operation. The IP telephone 801 sends “REFER” containing a Refer-to header in which the URI (192.168.1.3) of the IP telephone 803 and session information of the Call B are described, to the IP telephone 802. Next, the IP telephone 802 sends a “202 Accepted” reply in response to this “REFER”, to the IP telephone 801, and thereafter sends “NOTIFY” to the IP telephone 801. The IP telephone 801 sends a “200 OK” reply in response to this “NOTIFY” to the IP telephone 802.

Thereafter, the IP telephone 802 sends an “INVITE” request in which the session information of the Call B is described in the Replaces header, to the IP telephone 803. The IP telephone 803 sends a “200 OK” reply in response to this “INVITE” request, to the IP telephone 802. As a result, “Call C” is established between the IP telephone 802 and the IP telephone 803. In order to cut off the Call B described in the Replaces header, the IP telephone 803 sends a “BYE” request to the IP telephone 801. After receiving the “200 OK” reply in response to the “INVITE” request from the IP telephone 803, the IP telephone 802 sends “NOTIFY” containing “200 OK” indicative of transfer completion, to the IP telephone 801. The IP telephone 801 sends a “200 OK” reply in response to this “NOTIFY”, and sends a “BYE” request to the IP telephone 802 in order to cut off the Call A. The IP telephone 802 sends a “200 OK” reply in response to this “BYE”, to the IP telephone 801. As a result of the above-described procedure, the IP telephone 802 and the IP telephone 803 are enabled to make a call, and the transfer is completed.

Next, the SIP sequence in the case where a two-party call is to be switched to a three-party call will be described with reference to FIG. 19. FIG. 19 is a view showing an example of a transition sequence from a two-party call to a three-party call in a telephone service compliant with the SIP. First, the IP telephone 801 sends an “INVITE” request to the IP telephone 802. In response to this “INVITE” request, the IP telephone 802 sends a “200 OK” replay to the IP telephone 801. As a result, “Call A” is established between the IP telephone 801 and the IP telephone 802.

When the IP telephone 803 sends an “INVITE” request to the IP telephone 801 in the state where the Call A is established, the IP telephone 801 sends a “180 Ringing” reply indicative of calling, to the IP telephone 803. When a call switching operation is performed on the IP telephone 801, the IP telephone 801 sends an “UPDATE” request to the IP telephone 802. In response to this “UPDATE” request, the IP telephone 802 sends a “200 OK” replay to the IP telephone 801. As a result, the Call A between the IP telephone 801 and the IP telephone 802 is put on hold.

Next, the IP telephone 801 sends a “200 OK” replay to the IP telephone 803. As a result, “Call B” is established between the IP telephone 801 and the IP telephone 803. When an operation of switching to a three-party call is then performed on the IP telephone 801, the IP telephone 801 sends an “INVITE” request to the conference server 810. The conference server 810 sends a “200 OK” reply in response to this “INVITE” request, to the IP telephone 801, to establish “Conference C” in which the IP telephone 801 participates.

Thereafter, the IP telephone 801 sends “REFER” containing a Refer-to header in which the URI (192.168.1.2) of the IP telephone 802 and session information of the Call A are described, to the conference server 810. Next, the conference server 810 sends a “202 Accepted” reply in response to this “REFER”, to the IP telephone 801, and thereafter sends “NOTIFY” to the IP telephone 801. The IP telephone 801 sends a “200 OK” reply in response to this “NOTIFY” to the conference server 810. Thereafter, the conference server 810 sends an “INVITE” request in which the session information of the Call B is described in the Replaces header, to the IP telephone 802. The IP telephone 802 sends a “200 OK” reply in response to this “INVITE” request, to establish “Conference D”. In order to cut off the Call B described in the Replaces header, the IP telephone 802 then sends a “BYE” request to the IP telephone 801.

In the same procedure as that in which the IP telephone 802 is caused to participate in the conference, the IP telephone 801 causes also the IP telephone 803 to participate in the conference. As a result, the IP telephones 801, 802, 803 establish the Conference C, the Conference D, and a Conference E between the conference server 810 as conference sessions, respectively, and therefore a three-party call through the conference server 810 is established.

Next, an example of a video conference will be described. FIG. 20 is a view showing an example of the network configuration of a video conference system compliant with the SIP. In the system shown in FIG. 20, video conference terminals 901 to 904 are connected to one another through a network 900. Each of the video conference terminals 901 to 904 incorporates a conference server, and, in the case where a call among three or more parties is to be performed, conducts communication through the incorporated conference server.

In the system shown in FIG. 20, switching to a three-party call during a four-party call is performed in the following procedure. When the video conference terminal 904 is cut off during when the video conference terminals 901 to 904 perform a call by using the incorporated conference server of the video conference terminal 901, the call with the video conference terminal 904 is cut off, and a three-party call between the video conference terminals 901 to 903 is performed.

The SIP sequence in the case where a four-party call is switched to a three-party call in a video conference is shown in FIG. 21. FIG. 21 is a view showing an example of the SIP sequence in the case where a four-party call is switched to a three-party call. The video conference terminals 901 to 904 establish a call through the incorporated conference server 910 of the video conference terminal 901. At this time, the video conference terminal 904 sends a “BYE” request to the conference server 910 in order to leave the conference. In response to this “BYE”, the conference server 910 sends “200 OK” to the video conference terminal 904. As a result, switching to a three-party call by the video conference terminals 901 to 903 is performed, and the three-party call is enabled.

In the system shown in FIG. 20, in the case where the video conference terminal using the incorporated conference server is cut off during a four-party call, usually, transition to a three-party call is not performed, and all the video conference terminals cut off the call to the incorporated conference server to terminate the conference. This is performed because, in the case where a three-party call is to be continued, the conference server must be transitioned.

The SIP sequence in the case where the video conference terminal using the incorporated conference server is cut off is shown in FIG. 22. FIG. 22 is a view showing an example of the SIP sequence in the case where the video conference terminal using the incorporated conference server is cut off. The video conference terminals 901 to 904 establish a call through the incorporated conference server 910 of the video conference terminal 901. At this time, the video conference terminal 901 sends a “BYE” request to the incorporated conference server 910 in order to leave the conference. In response to this “BYE” request, the conference server 910 sends a “200 OK” reply to the video conference terminal 901.

Thereafter, the conference server 910 sends a “BYE” request to each of the video conference terminals 902 to 904. Next, the video conference terminals 902 to 904 send a “200 OK” reply in response to this “BYE” request to the conference server 910 to cut off the call. This causes the conference to be ended.

As described above, according to the method, because of the use of the endpoint number switch method compliant with the SIP, it is possible to realize the endpoint number switch even in the case where video conference terminals incorporating a conference server are used. In the case where a video conference terminal using the incorporated conference server is to leave the conference, however, the conference must be ended because a transition of the conference server cannot be performed.

Patent Reference 1 shows an example of the conference server transition method. In the method of Patent Reference 1, a conference server incorporated in a video conference terminal which leaves a conference sends a server movement request to a conference server incorporated in another video conference terminal. In order to acquire current conference information, the conference server which receives the server movement request transmits an acquisition message to the conference server incorporated in the video conference terminal which leaves the conference. Next, the conference server which receives the server movement request acquires the current conference information from a reply message in response to the acquisition message, and starts a conference in accordance with the current conference information. In this way, the conference server is transitioned.

### PRIOR ART REFERENCE

### Patent Reference

Patent Reference 1: JP-A-10-289185

### SUMMARY OF THE INVENTION

### Problems that the Invention is to Solve

In the above-described transfer method and endpoint number change method compliant with the SIP, a complicated sequence using the “REFER” method and the “NOTIFY” method is executed. Therefore, IP telephones and conference servers which construct the system must be terminals which support these extension methods defined by the SIP. In other words, with respect to a terminal which does not support these extension methods, the above-described transfer method and endpoint number change method cannot be executed.

Moreover, methods such as “REFER” and “NOTIFY” are not a basic method such as the “BYE” method, but are extension methods which realize system function expansion. Therefore, a sequence for realizing a transfer or an endpoint number change is complicated, and a large number of development man-hours are required. In relation to a conference server transition method, in the above-described method of Patent Reference 1, the conference server transmits and receives unique messages which are not defined in standard specifications.

Therefore, the method has a problem in that, with respect to a conference server which does not correspond to the method, the conference server cannot be transitioned. Since unique messages are used, a large number of man-hours for developing the method are required.

It is an object of the invention to provide a communication apparatus, a communication system, and a session control method in which a transfer, an endpoint number change, or a conference server transition can be performed by using a basic method of a call control protocol.

### Means for Solving the Problems

The invention provides a communication apparatus which controls a session with respect to at least one other communication apparatus by using a basic method or a reply of a call control protocol, the communication apparatus comprising:

a message receiving section that receives a message which is transmitted from the other communication apparatus, and the message in which reconnection control information related to an operation after an end of the session is described in the basic method or the reply; and

a first controlling section that performs a reconnection control based on the reconnection control information contained in the message.

The invention provides a communication apparatus which controls a session with respect to at least one other communication apparatus by using a basic method or a reply of a call control protocol, the communication apparatus comprising:

a first message producing section that produces a message in which reconnection control information related to an operation after an end of the session is described in the basic method or the reply; and

a message transmitting section that transmits the message produced by the first message producing section, to the other communication apparatus.

The invention provides a communication apparatus which controls a session with respect to at least one other communication apparatus by using a basic method or a reply of a call control protocol, the communication apparatus comprising:

a first message producing section that produces a message in which reconnection control information related to an operation after an end of the session is described in the basic method or the reply;

a message transmitting section that transmits the message produced by the first message producing section, to the other communication apparatus and that receives a message which is sent from the other communication apparatus; and

a first controlling section that performs a reconnection control based on the reconnection control information contained in the message which is sent from the other communication apparatus.

The invention provides a communication apparatus which controls a mutual session among three or more communication apparatuses by using a basic method or a reply of a call control protocol, the communication apparatus comprising:

a second message producing section that produces a message in which reconnection control information related to an operation after an end of the session is described in the basic method;

a second controlling section that performs a reconnection control based on the reconnection control information contained in the message which is sent from another communication apparatus; and

a transmitting and receiving section which transmits the message produced by the second message producing section, to a plurality of communication apparatuses, and which receives a message which is sent from a communication apparatus.

The invention provides a communication system in which a session among a plurality of communication apparatuses is controlled by using a basic method of a call control protocol, wherein each of the plurality of communication apparatuses including:

a first message producing section that produces a message in which reconnection control information related to an operation after an end of the session is described in the basic method or the reply;

a message transmitting and receiving section that transmits the message produced by the first message producing section, to another communication apparatus, and that receives a message which is sent from the other communication apparatus; and

a first controlling section that performs a reconnection control based on the reconnection control information contained in the message which is sent from the other communication apparatus.

The invention provides a session control method of controlling a session among a plurality of communication apparatuses by using a basic method or a reply of a call control protocol, wherein each of the plurality of communication apparatuses including:

a message producing section which produces a message in which first reconnection control information instructing to maintain an idle state until a session start request is issued from a designated communication apparatus, or second reconnection control information instructing a designated communication apparatus to issue a session start request is described in the basic method or the reply; and

a message transmitting and receiving section which transmits the message produced by the message producing section, to another communication apparatus, and which receives a message which is sent from the other communication apparatus; and

wherein the each of the plurality of communication apparatuses performs a reconnection control based on the reconnection control information contained in the message which is sent from the other communication apparatus. Effects of the Invention

According to the communication apparatus, communication system, and session control method of the invention, a transfer, an endpoint number change service, or a conference server transition can be performed by using a basic method of a call control protocol.

### BRIEF DESCRIPTION OF THE DRAWINGS

FIG. 1 is a view showing an example of the network configuration of a video conference system compliant with the SIP.

FIG. 2 is a block diagram showing the internal configuration of a conference terminal of a first embodiment.

FIG. 3 is a view showing an example of the transfer sequence in the video conference system of the first embodiment.

FIG. 4 is a flowchart showing the operation of a conference terminal 101 in the transfer sequence shown in FIG. 3.

FIG. 5 is a flowchart showing the operation of a conference terminal 103 in the transfer sequence shown in FIG. 3.

FIG. 6 is a flowchart showing the operation of a conference terminal 102 in the transfer sequence shown in FIG. 3.

FIG. 7 is a view showing an example of the network configuration of a video conference system compliant with the SIP.

FIG. 8 is a block diagram showing the internal configuration of a conference terminal of a second embodiment.

FIG. 9 is a block diagram showing the internal configuration of a conference server included in the conference terminal of the second embodiment.

FIG. 10 is a view showing an example of a transition sequence from a two-party call to a three-party call in a video conference system of the second embodiment.

FIG. 11 is a flowchart showing the operation of a conference terminal 201 in the transition sequence shown in FIG. 10.

FIG. 12 is a flowchart showing the operation of a conference terminal 203 in the transition sequence shown in FIG. 10.

FIG. 13 is a flowchart showing the operation of a conference terminal 202 in the transition sequence shown in FIG. 10.

FIG. 14 is a view showing an example of a transition sequence from a three-party call to a two-party call in a video conference system of a third embodiment.

FIG. 15 is a view showing an example of a transition sequence from a four-party call to a three-party call in a video conference system of a fourth embodiment.

FIG. 16 is a flowchart showing the operation of a conference terminal 202 in the transition sequence in the third embodiment shown in FIG. 14 and the transition sequence in the fourth embodiment shown in FIG. 15.

FIG. 17 is a view showing an example of the network configuration of a telephone service system compliant with the SIP.

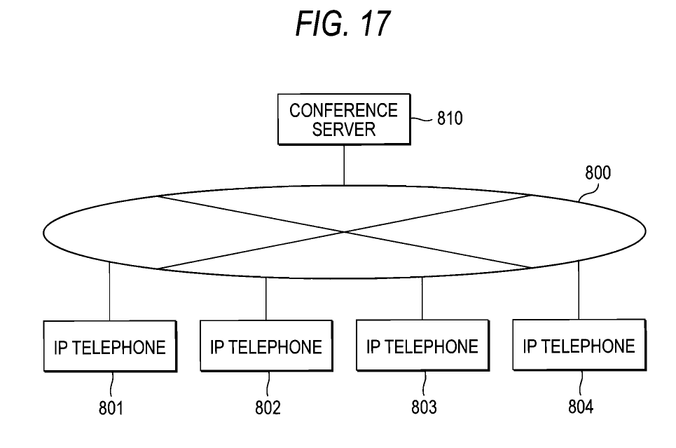

FIG. 18 is a view showing an example of the transfer sequence in a telephone service compliant with the SIP.

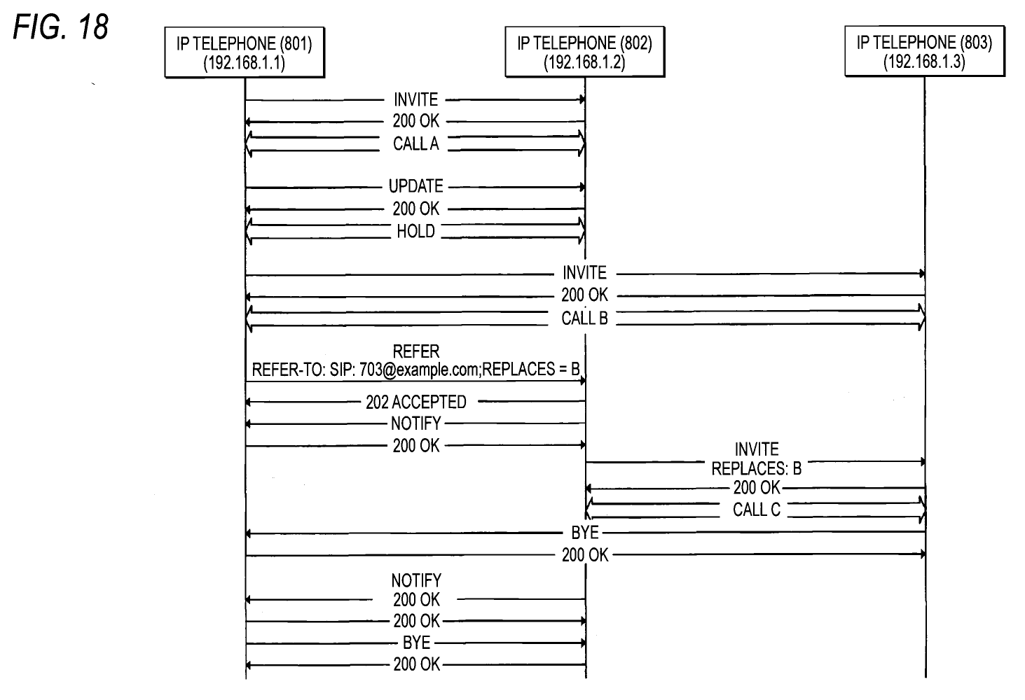

FIG. 19 is a view showing an example of a transition sequence from a two-party call to a three-party call in a telephone service compliant with the SIP.

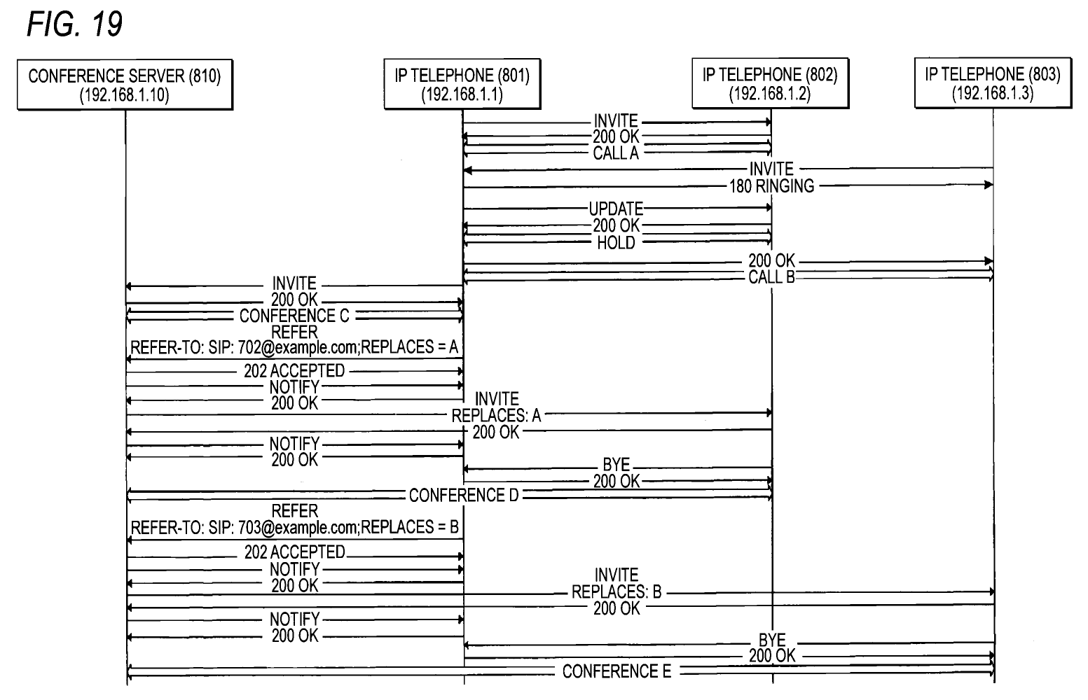

FIG. 20 is a view showing an example of the network configuration of a video conference system compliant with the SIP.

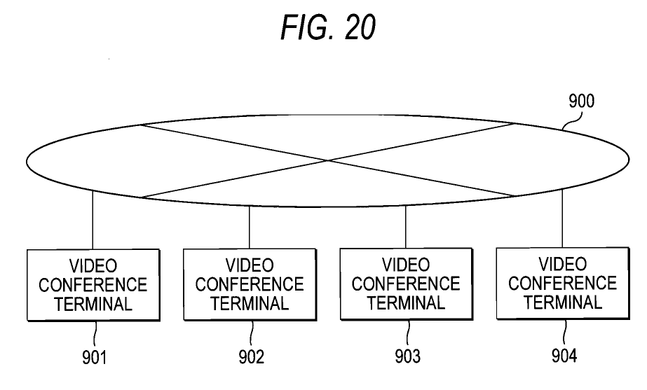

FIG. 21 is a view showing an example of the SIP sequence in the case where a four-party call is switched to a three-party call.

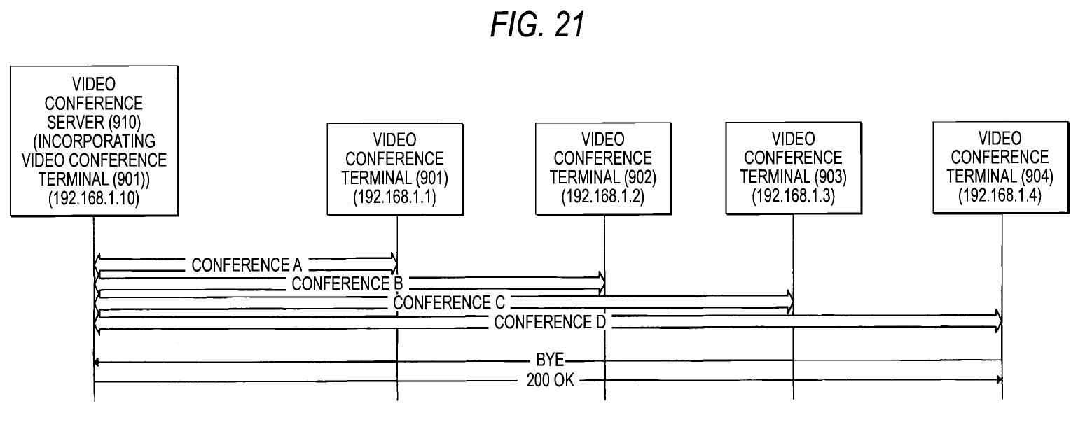

FIG. 22 is a view showing an example of the SIP sequence in the case where a video conference terminal using an incorporated conference server is cut off.

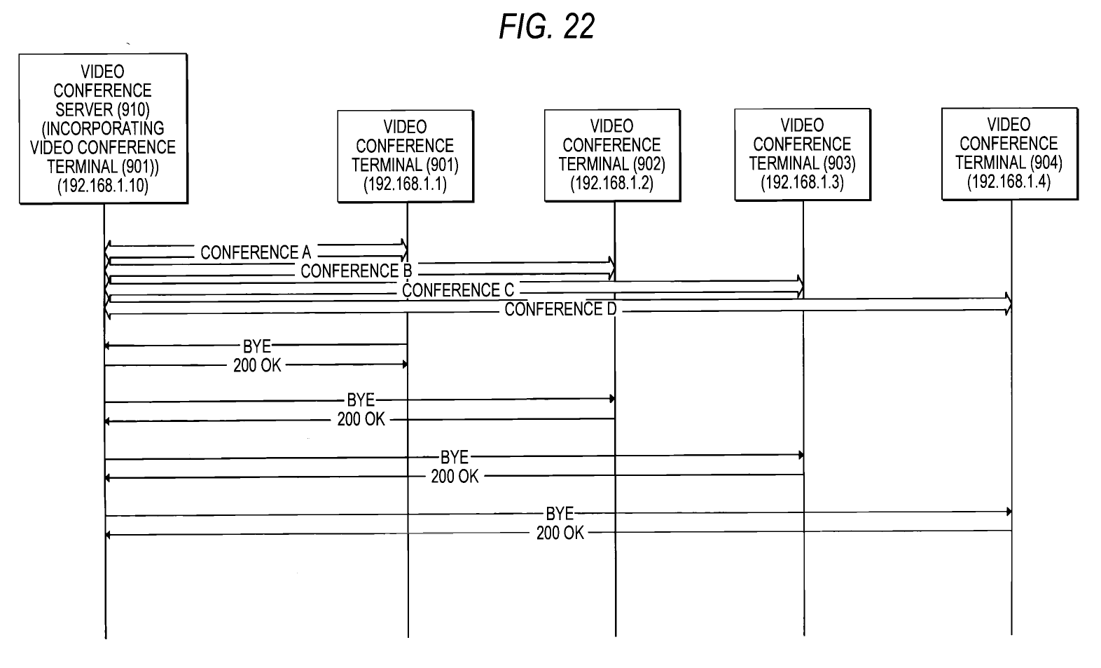

### DESCRIPTION OF EMBODIMENTS

Hereinafter, embodiments of the invention will be described with reference to the drawings. Although, in the embodiments which will be described hereinafter, an example of a multi-point video conference will be shown, even an audio conference or other conference communication can be realized by a similar procedure. The embodiments will be described by using the SIP as a communication protocol used in the conference. As the communication protocol, alternatively, another communication protocol such as H.323 or HTTP may be used.

### First Embodiment

In a first embodiment, an example of a transfer service which is realized by transmitting and receiving a basic method of the SIP (Session Initiation Protocol) containing reconnection control information will be described.

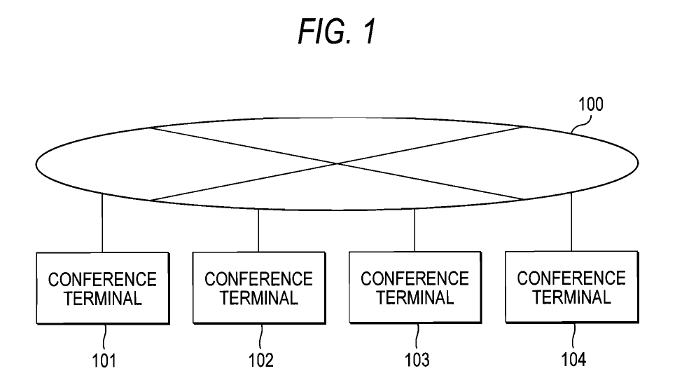

FIG. 1 is a view showing an example of the network configuration of a video conference system compliant with the SIP. In the system shown in FIG. 1, conference terminals 101 to 104 compliant with a basic method of the SIP defined in RFC 3261 or the like are connected to one another through a network 100. The network 100 is the Internet, an in-company LAN, an in-house network, or another network. The basic method of the SIP includes an “INVITE” request, an “UPDATE” request, a “BYE” request, and replies to these requests such as “200 OK”. These requests and replies are called “message”. The “INVITE” request is a message requesting a session to be started. The “UPDATE” request is a message requesting an established session to be put on hold. The “BYE” request is a message requesting a session to be ended.

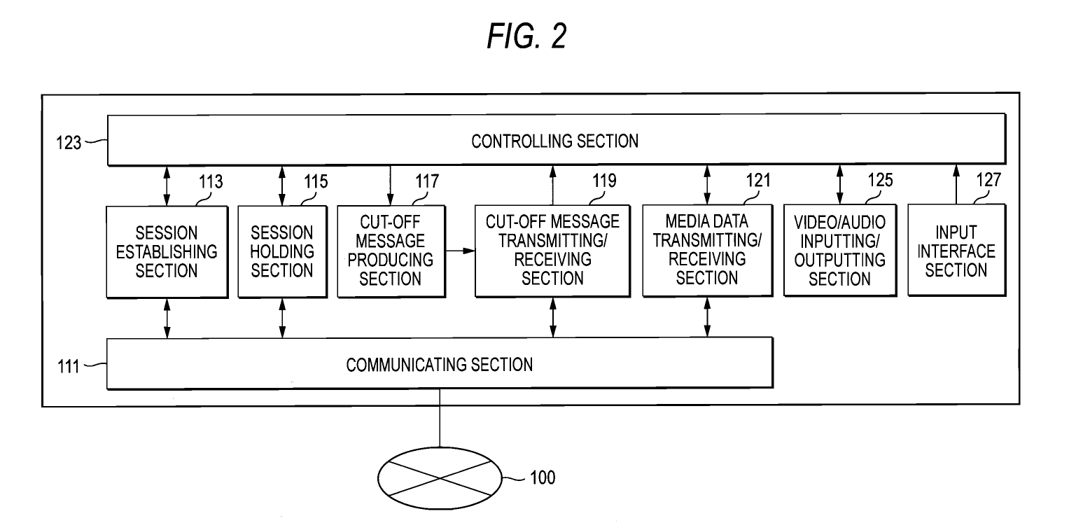

FIG. 2 is a block diagram showing the internal configuration of a conference terminal of the first embodiment. As shown in FIG. 2, each of the conference terminals 101 to 104 used in the video conference system includes a communicating section 111, a session establishing section 113, a session holding section 115, a cut-off message producing section 117, a cut-off message transmitting and receiving section 119, a media data transmitting and receiving section 121, a controlling section 123, a video/audio inputting/outputting section 125, and an input interface section 127.

The communicating section 111 communicates with the other conference terminals through the network 100.

The session establishing section 113 transmits and receives, between conference terminals, an “INVITE” request and “200 OK” replay in response to the request through the communicating section 111. When the transmission and reception of the “INVITE” request and the “200 OK” reply are completed, the session establishing section 113 establishes a session between the conference terminals. As a result, a call state is set between the conference terminals.

The session holding section 115 transmits and receives, between the conference terminals in which the session is established, the “UPDATE” request and “200 OK” replay in response to the request through the communicating section 111. When the transmission and reception of the “UPDATE” request and the “200 OK” reply are completed, the session holding section 115 puts the call between the conference terminals on hold.

The cut-off message producing section 117 produces a “BYE” request in which reconnection control information is described in the Reason header. The “BYE” request is a message for ending a session. As the reconnection control information, there are two kinds of information, or information instructing that the incoming call waiting state (idle state) be maintained until an incoming call is received from another conference terminal, and that instructing that transmission to a specific terminal be made. For example, the first reconnection control information is expressed as “process=recv;from=“sip:192.168.1.2””. The reconnection control information instructs that the incoming call waiting state (idle state) be held until an “INVITE” request is received from a conference terminal in which the SIP URI functioning as identification information is “sip:192.168.1.2”. For example, the second reconnection control information is expressed as “process=send;to=“sip:192.168.1.3””. The reconnection control information instructs that an “INVITE” request be sent to a conference terminal in which the SIP URI is “sip:192.168.1.3”.

As the identification information of a conference terminal, an IP address, a MAC address, or the like may be used in place of the SIP URI. The message for ending a session may be a request other than the “BYE” request. The reconnection control information is not limited to be described in the Reason header of the “BYE” request, and may be described in another head or body of the “BYE” request.

The cut-off message transmitting and receiving section 119 transmits the “BYE” request produced by the cut-off message producing section 117, and a “200 OK” reply in response to the “BYE” request sent from another conference terminal, through the communicating section 111. The cut-off message transmitting and receiving section 119 receives a “BYE” request and “200 OK” reply sent from another conference terminal, through the communicating section 111. When the transmission and reception of the “BYE” request and the “200 OK” reply are completed, the cut-off message transmitting and receiving section 119 ends the session which is established between the conference terminals. At this time, the conference terminals participating in a call are set to the idle state.

The video/audio inputting/outputting section 125 is a camera, a microphone, a display, a speaker, and the like. The media data transmitting and receiving section 121 transmits and receives media data such as video data or audio data which are input/output through the video/audio inputting/outputting section 125, between conference terminals through the communicating section 111. The input interface section 127 is an interface through which the user of the conference terminal inputs set information and the like in the conference terminal.

The controlling section 123 controls the various sections included in the conference terminal. When the cut-off message transmitting and receiving section 119 receives the “BYE” request, the controlling section 123 processes the session so as to be ended. When the controlling section 123 ends the session, the conference terminal enters the idle state. Moreover, the controlling section 123 refers the reconnection control information described in the Reason header of the “BYE” request received by the cut-off message transmitting and receiving section 119, and performs an operation instructed by the reconnection control information.

In the video conference system shown in FIG. 1, a transfer to the conference terminal 103 during a two-party call between the conference terminal 101 and the conference terminal 102 is performed in the following procedure. The SIP URI (Uniform Resource Identifier) of the conference terminal 101 is “sip:192.168.1.1”. The SIP URI of the conference terminal 102 is “sip:192.168.1.2”. The SIP URI of the conference terminal 103 is “sip:192.168.1.3”. The SIP designates the session partner by designating the URI which is a common address of an application layer.

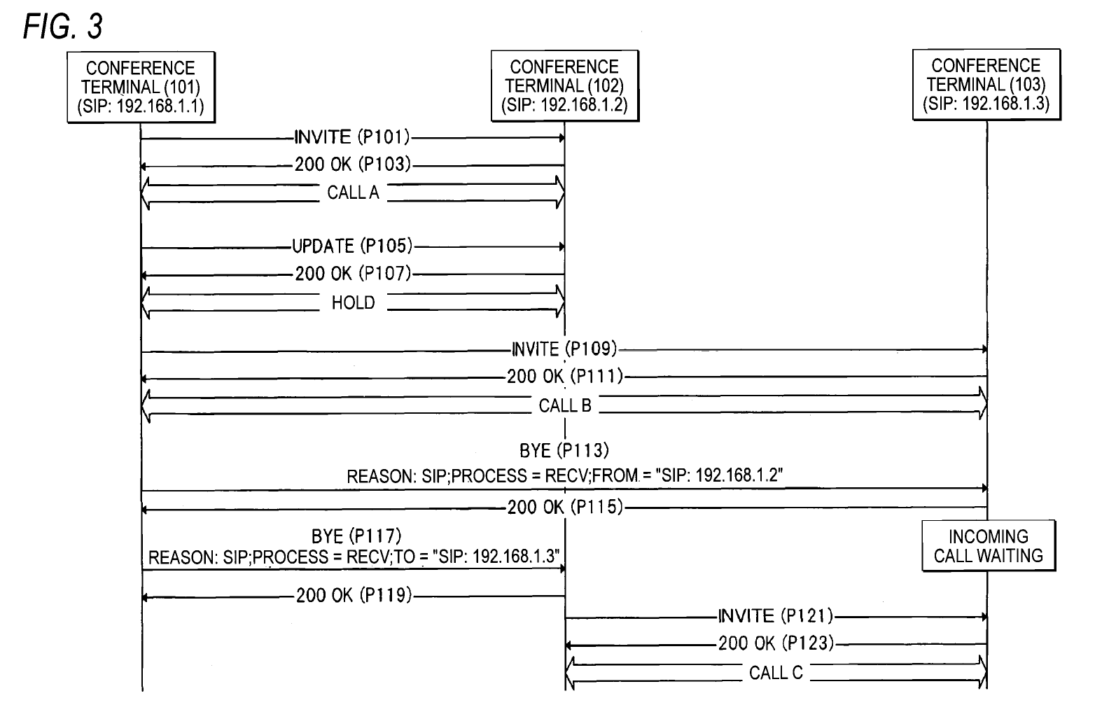

FIG. 3 is a view showing an example of the transfer sequence in the video conference system of the first embodiment. In FIG. 3, the illustration of “ACK” is omitted. First, the conference terminal 101 sends an “INVITE” request to the conference terminal 102 (P101). In response to this “INVITE” request, the conference terminal 102 sends a “200 OK” reply to the conference terminal 101 (P103). As a result, session “Call A” is established between the conference terminal 101 and the conference terminal 102.

When a holding operation is performed on the conference terminal 101 in the state where the Call A is established, the conference terminal 101 sends an “UPDATE” request to the conference terminal 102 (P105). In response to this “UPDATE” request, next, the conference terminal 102 sends a “200 OK” reply to the conference terminal 101 (P107). As a result, session “Call A” between the conference terminal 101 and the conference terminal 102 is put on hold.

Next, when an operation of calling the conference terminal 103 is performed on the conference terminal 101, the conference terminal 101 sends an “INVITE” request to the conference terminal 103 (P109). In response to this “INVITE” request, the conference terminal 103 sends a “200 OK” reply to the conference terminal 101 (P111). As a result, session “Call B” is established between the conference terminal 101 and the conference terminal 103.

Thereafter, the conference terminal 101 sends a “BYE” request for ending the Call B to the conference terminal 103 (P113). In the Reason header of the “BYE” request, reconnection control information instructing that an incoming call from the conference terminal 102 (sip:192.168.1.2) be waited is described. For example, the reconnection control information is described as “process=recv;from=“sip:192.168.1.2””. The conference terminal 103 sends a “200 OK” reply in response to this “BYE” request to the conference terminal 101 (P115). Thereafter, the conference terminal 103 transitions into the idle state, and enters a state where an incoming call from the conference terminal 102 is waited.

Next, the conference terminal 101 sends a “BYE” request for ending the Call A to the conference terminal 102 (P117). In the Reason header of the “BYE” request, reconnection control information instructing that an outgoing call to the conference terminal 103 (sip:192.168.1.3) be made is described. For example, the reconnection control information is described as “process=send;to=“sip:192.168.1.3””. The conference terminal 102 sends a “200 OK” reply in response to this “BYE” request to the conference terminal 101 (P119).

In accordance with the reconnection control information described in the Reason header of the “BYE” request sent from the conference terminal 101, the conference terminal 102 sends an “INVITE” request to the conference terminal 103 (P121). The conference terminal 103 sends a “200 OK” reply in response to this “ INVITE” request to the conference terminal 102 (P123). As a result, session “Call C” is established between the conference terminal 102 and the conference terminal 103. In this way, a transfer service in which the call between the conference terminal 101 and the conference terminal 102 is switched to that between the conference terminal 102 and the conference terminal 103 is realized.

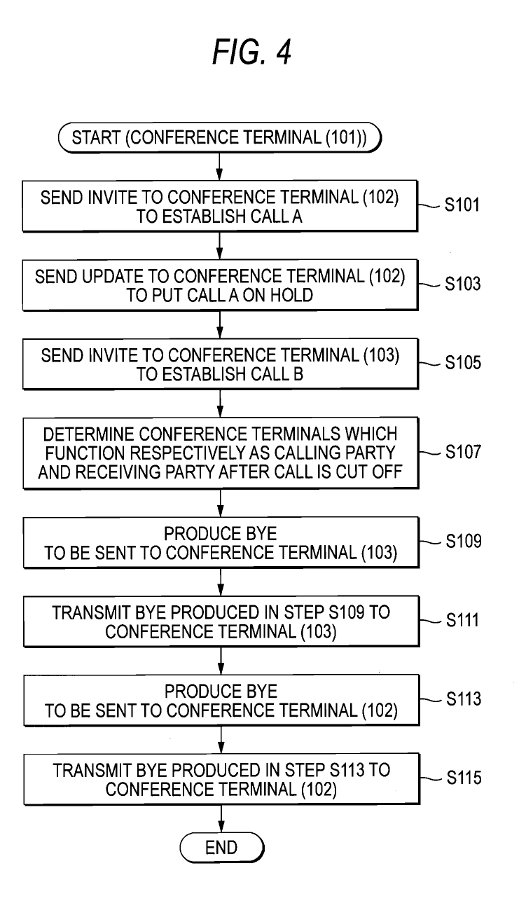

FIG. 4 is a flowchart showing the operation of the conference terminal 101 in the transfer sequence shown in FIG. 3. First, the session establishing section 113 sends an “INVITE” request to the conference terminal 102 to establish the Call A (S101). Then, the session holding section 115 sends an “UPDATE” request to the conference terminal 102 to put the Call A on hold (S103). Thereafter, the session establishing section 113 sends an “INVITE” request to the conference terminal 103 to establish the call B (S105).

The controlling section 123 determines conference terminals which function respectively as the calling party and the receiving party after the call between the conference terminal 101 and the conference terminal 102 is cut off (S107). The calling party and the receiving party may be determined by any method, for example, by setting the terminal having a smaller identification information number, as the calling party. In the embodiment, an example in which it is determined that the conference terminal functioning as the calling party is the conference terminal 102, and that functioning as the receiving party is the conference terminal 103 will be described.

Next, the cut-off message producing section 117 produces a “BYE” request which is to be sent to the conference terminal (conference terminal 103) that will function as the receiving party (S109). The cut-off message producing section 117 describes the reconnection control information instructing that an incoming call from the conference terminal 102 (sip:192.168.1.2) be waited, in the Reason header of the “BYE” request. For example, the reconnection control information is described as “process=recv;from=“sip:192.168.1.2””. Next, the cut-off message transmitting and receiving section 119 sends the “BYE” request which is produced by the cut-off message producing section 117, to the conference terminal 103 (S111).

Next, the cut-off message producing section 117 produces a “BYE” request which is to be sent to the conference terminal (conference terminal 102) that will function as the calling party (S113). The cut-off message producing section 117 describes the reconnection control information instructing that an outgoing call to the conference terminal 103 (sip:192.168.1.3) be made, in the Reason header of the “BYE” request. For example, the reconnection control information is described as “process=send;to=“sip:192.168.1.3””. Next, the cut-off message transmitting and receiving section 119 sends the “BYE” request which is produced by the cut-off message producing section 117, to the conference terminal 102 (S115).

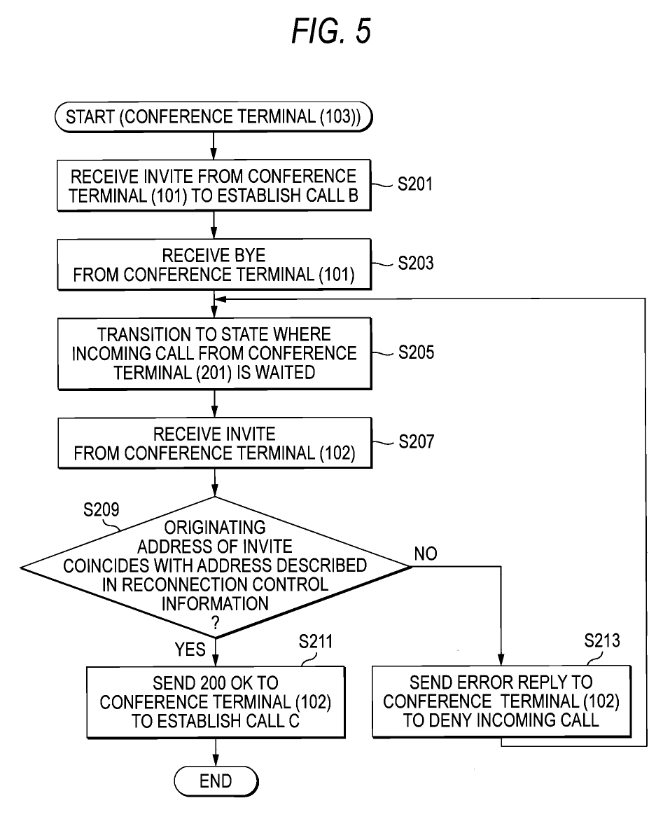

FIG. 5 is a flowchart showing the operation of the conference terminal 103 in the transfer sequence shown in FIG. 3. First, the session establishing section 113 receives the “INVITE” request from the conference terminal 101 to establish the call B (S201). Next, the cut-off message transmitting and receiving section 119 receives a “BYE” request from the conference terminal 101 (S203). In the Reason header of the “BYE” request, reconnection control information instructing that an incoming call from the conference terminal 102 (sip:192.168.1.2) be waited is described. For example, the reconnection control information is described as “process=recv;from=“sip:192.168.1.2””.

Next, the controlling section 123 sets the own terminal (conference terminal 103) to a state where an incoming call from the conference terminal 102 is waited, in accordance with the reconnection control information described in the received “BYE” request (S205). Thereafter, the session establishing section 113 receives the “INVITE” request from the conference terminal 102 (S207). The controlling section 123 determines whether or not the originating address of the “INVITE” request coincides with the address described in the reconnection control information of the “BYE” request which is received in step S203 (S209). The controlling section 123 determines the originating address of the “INVITE” request while referring the From header or the like of the “INVITE” request.

If these addresses coincide with each other, the session establishing section 113 sends a “200 OK” reply to the conference terminal 102 to establish the call C (S211). If these addresses do not coincide with each other, the session establishing section 113 performs the following process. The session establishing section 113 sends an error reply (03 Forbidden or the like) in response to the “INVITE” request which is received in step S207, to the conference terminal 102 to deny an incoming call (S213), and again sets the own terminal to the incoming call waiting state. In step S213, the session establishing section 113 may not send the error reply, and may ignore the “INVITE” request.

In the foregoing description, it has been described that the controlling section 123 determines in step S209 whether or not the originating address of the “INVITE” request coincides with the address described in the reconnection control information of the “BYE” request which is received in advance of receiving it. However, the controlling section 123 of the conference terminal 103 may not perform the determination. Namely, the controlling section 123 of the conference terminal 103 may not have the function of referring the reconnection control information described in the “BYE” request. In this case, step S213 is not performed. However, there is a case where the session establishing section 113 of the conference terminal 103 receives an “INVITE” request from a conference terminal other than the conference terminal 102. In this case, the session establishing section 113 of the conference terminal 103 sends a “200 OK” reply in response to the “INVITE” request to this conference terminal, and establishes a session.

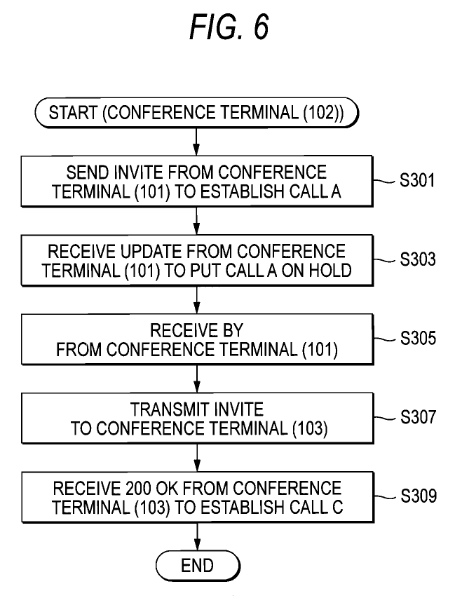

FIG. 6 is a flowchart showing the operation of the conference terminal 102 in the transfer sequence shown in FIG. 3. First, the session establishing section 113 receives the “INVITE” request from the conference terminal 101 to establish the Call A (S301). Then, the session holding section 115 receives the “UPDATE” request from the conference terminal 101 to put the Call A on hold (S303).

Next, the cut-off message transmitting and receiving section 119 receives the “BYE” request from the conference terminal 101 (S305). In the Reason header of the “BYE” request, reconnection control information instructing that an outgoing call to the conference terminal 103 (sip:192.168.1.3) be made is described. For example, the reconnection control information is described as “process=send;to=“sip:192.168.1.3””. The session establishing section 113 sends an “INVITE” request to the conference terminal 103 in accordance with the reconnection control information described in the “BYE” request which is received in step 5305 (S307). Thereafter, the session establishing section 113 receives a “200 OK” reply in response to the “INVITE” request which is sent in step S307, to establish the call C (S309).

In the first embodiment, as described above, the cut-off message producing section 117 of the conference terminal 101 describes instructions related to an operation (outgoing or incoming call) which is to be performed by each conference terminal, and the address of the outgoing or incoming destination, as reconnection control information in the “BYE” request. A conference terminal which receives the “BYE” request performs the operation instructed by the reconnection control information, thereby realizing a transfer service.

In the embodiment, as described above, only a basic method of the SIP defined in RFC 3261 or the like is used in order to realize a transfer service. In the embodiment, if a conference terminal corresponds to the basic method of the SIP, therefore, the conference terminal can easily realize a transfer service without performing a complicated process. Namely, even a conference terminal which does not correspond to an extension method, or that which uses unique messages can realize a transfer service without losing connectivity, as far as it corresponds to the basic method of the SIP. In the embodiment, moreover, man-hours for developing the transfer service can be reduced. Furthermore, the number of messages to be transmitted or received is reduced, and hence the time required for executing the service can be shortened.

The SIP is a protocol in which an incomprehensible header is ignored. In the case where the conference terminal 103 is a terminal which does not refer the reconnection control information described in the Reason header of a “BYE” request that is received from another conference terminal, therefore, the conference terminal does nothing but ignore the Reason header. However, the conference terminal 103 ends the session in accordance with the “BYE” request to enter the incoming call waiting state, and therefore the transfer service can be realized.

### Second Embodiment

In a second embodiment, an example of a transition service from a two-party call to a three-party call which is realized by transmitting and receiving a basic method of the SIP containing reconnection control information will be described.

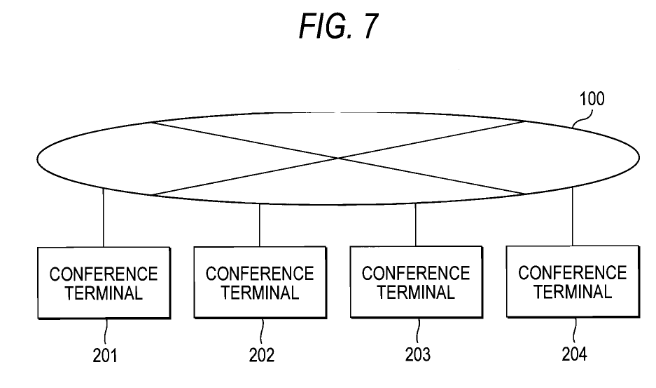

FIG. 7 is a view showing an example of the network configuration of a video conference system compliant with the SIP. In the system shown in FIG. 7, conference terminals 201 to 204 compliant with a basic method of the SIP defined in RFC 3261 or the like are connected to one another through the network 100. The network 100 is the Internet, an in-company LAN, an in-house network, or another network.

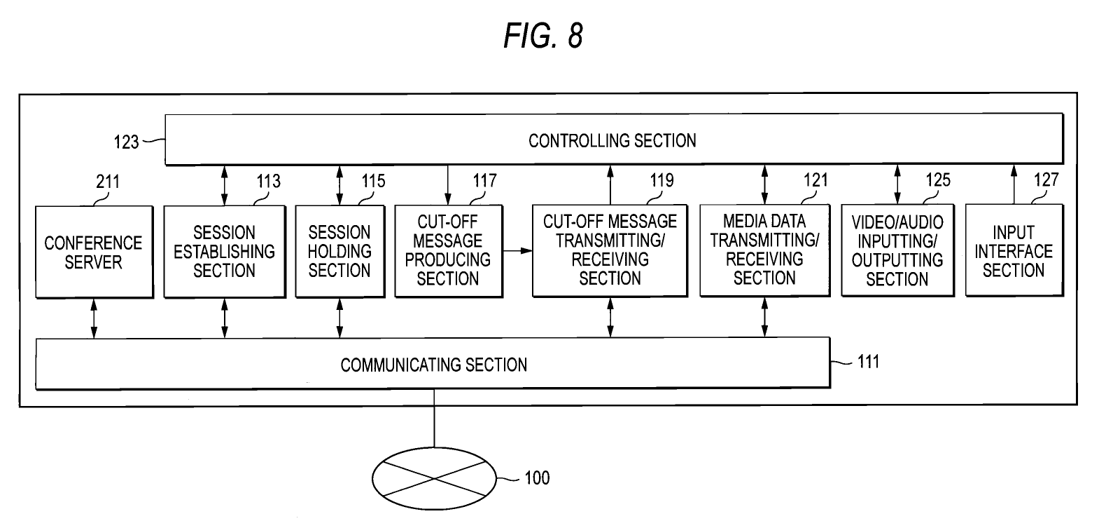

FIG. 8 is a block diagram showing the internal configuration of a conference terminal of the second embodiment. In a similar manner as the conference terminals of the first embodiment, as shown in FIG. 8, each of the conference terminals 201 to 204 used in the video conference system includes the communicating section 111, the session establishing section 113, the session holding section 115, the cut-off message producing section 117, the cut-off message transmitting and receiving section 119, the media data transmitting and receiving section 121, the controlling section 123, the video/audio inputting/outputting section 125, and the input interface section 127. Furthermore, each of the conference terminals 201 to 204 includes a conference server 211. In FIG. 8, the components which are common to FIG. 2 are denoted by the same reference numerals.

The conference server 211 is used in the case where a conference among three or more parties is performed. At this time, a communication between conference terminals is performed through the conference server of any one of the three conference terminals. In the conference server, session establishment with respect to the conference terminals, and a relay of a communication between the conference terminals are performed through the communicating section 111.

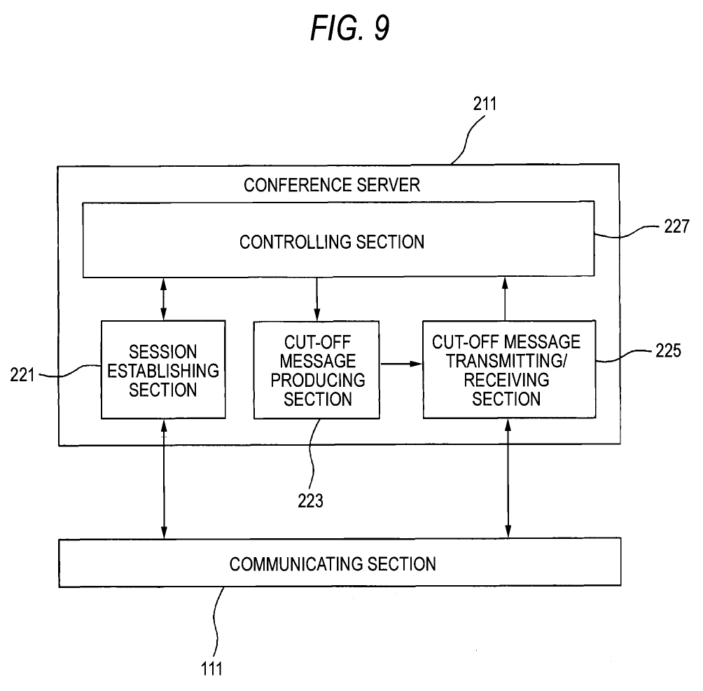

FIG. 9 is a block diagram showing the internal configuration of the conference server 211 included in the conference terminal of the second embodiment. As shown in FIG. 9, the conference server 211 has a session establishing section 221, a cut-off message producing section 223, a cut-off message transmitting and receiving section 225, and a controlling section 227.

The session establishing section 221 transmits and receives, between conference terminals, an “INVITE” request and a “200 OK” replay in response to the request through the communicating section 111 of the conference terminal. When the transmission and reception of the “INVITE” request and the “200 OK” reply are completed, the session establishing section 221 establishes a session between the conference terminals. When, in the “INVITE” request sent from the conference terminal, the addresses of conference terminals in which a session is to be established are described as reconnection control information, the session establishing section 221 sends the “INVITE” request to the conference terminals of the addresses.

The cut-off message producing section 223 produces a “BYE” request in which reconnection control information is described in the Reason header. The reconnection control information to be described in the “BYE” request is similar to that described in the first embodiment. The cut-off message transmitting and receiving section 225 transmits the “BYE” request produced by the cut-off message producing section 223, and a “200 OK” reply in response to a “BYE” request sent from a conference terminal, through the communicating section 111 of the conference terminal. Furthermore, the cut-off message transmitting and receiving section 225 receives a “BYE” request and “200 OK” reply sent from a conference terminal, through the communicating section 111 of the conference terminal. When the transmission and reception of the “BYE” request and the “200 OK” reply are completed, the cut-off message transmitting and receiving section 225 ends the session which is established between the conference terminals.

The controlling section 227 controls the various sections included in the conference server 211. When the cut-off message transmitting and receiving section 225 receives a “BYE” request, the controlling section 227 processes the session so as to be ended.

In the video conference system shown in FIG. 8, a transition from a two-party call between the conference terminals 201, 202 to a three-party call between the conference terminals 201 to 203 is performed in the following procedure. In the three-party call, the conference server 211 of the conference terminal 201 is used. The SIP URI of the conference terminal 201 is “sip:192.168.1.1”. The SIP URI of the conference terminal 202 is “sip:192.168.1.2”. The SIP URI of the conference terminal 203 is “sip:192.168.1.3”. The SIP URI of the conference server 211 of the conference terminal 201 is “sip:192.168.1.1:55060”.

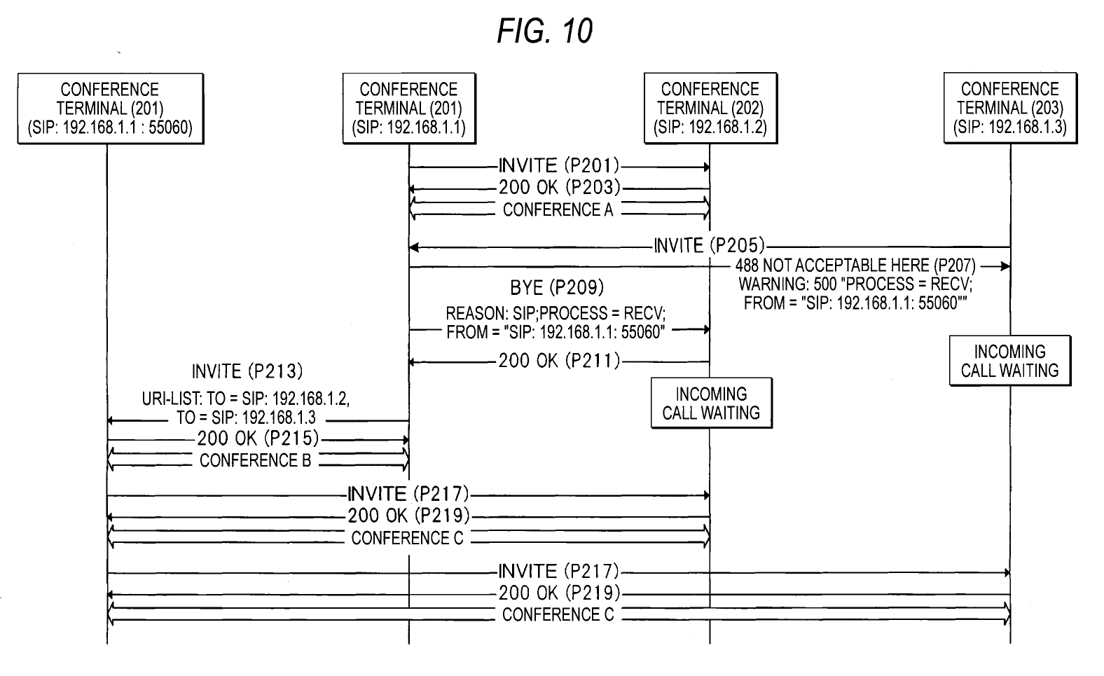

FIG. 10 is a view showing an example of the transition sequence from a two-party call to a three-party call in the video conference system of the second embodiment. In FIG. 10, the illustration of “ACK” is omitted. First, the conference terminal 201 sends an “INVITE” request to the conference terminal 202 (P201). The conference terminal 202 sends a “200 OK” reply in response to this “INVITE” request, to the conference terminal 201 (P203). As a result, “Call A” is established between the conference terminal 201 and the conference terminal 202.

In the state where the Call A is established, the conference terminal 203 sends an “INVITE” request to the conference terminal 201 (P205). In order to transition to a three-party call including the conference terminal 203, the conference terminal 201 sends a “488” reply in response to this “INVITE” request, to the conference terminal 203 (P207). In the Warning header of the “488” reply, reconnection control information instructing that an incoming call from the conference server 211 (sip:192.168.1.1:55060) of the conference terminal 201 be waited is described. For example, the reconnection control information is described as “process=recv;from=“sip:192.168.1.1:55060””. The “488” reply is produced by the cut-off message producing section 117 of the conference terminal 201. In accordance with the reconnection control information described in the Warning header of the “488” reply sent from the conference terminal 201, the conference terminal 203 enters a state where an incoming call from the conference server 211 of the conference terminal 201 is waited.

Next, the conference terminal 201 sends a “BYE” request for ending the Call A to the conference terminal 202 (P209). In the Reason header of the “BYE” request, reconnection control information instructing that an incoming call from the conference server 211 (sip:192.168.1.1:55060) of the conference terminal 201 be waited is described. For example, the reconnection control information is described as “process=recv;from=“sip:192.168.1.1:55060””. The conference terminal 202 sends a “200 OK” reply in response to this “BYE” request, to the conference terminal 201 (P211). In accordance with the reconnection control information described in the Reason header of the “BYE” request sent from the conference terminal 201, the conference terminal 202 enters a state where an incoming call from the conference server 211 of the conference terminal 201 is waited.

Next, the conference terminal 201 sends an “INVITE” request to the incorporated conference server 211 (sip:192.168.1.1:55060) (P213). The addresses of the conference terminals 202, 203 are described in the body of this “INVITE” request, as a connection destination list (URI-List). Alternatively, these addresses may be described in the expansion header or the like of the SIP. The session establishing section 221 of the conference server 211 of the conference terminal 201 sends a “200 OK” replay in response to this “INVITE” request, to the conference terminal 201 (P215). As a result, session “Conference B” is established between the conference server 211 and the conference terminal 201.

Next, the session establishing section 221 of the conference server 211 of the conference terminal 201 sends an “INVITE” request to each of the conference terminals 202, 203 (P217). The conference terminals 202, 203 send a “200 OK” replay in response to this “INVITE” request, to the conference server 211 of the conference terminal 201 (P219). As a result, session “Conference C” is established between the conference server 211 and the conference terminal 202, and session “Conference D” is established between the conference server 211 and the conference terminal 203, so that a three-party call between the conference terminals 201 to 203 is established. In this way, a service in which, during a two-party call between the conference terminal 201 and the conference terminal 202, transition to a three-party call including the conference terminal 203 is performed is realized.

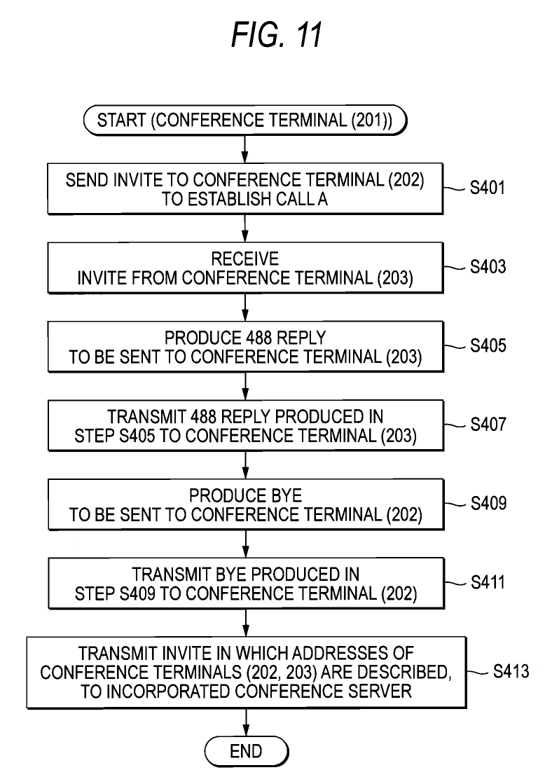

FIG. 11 is a flowchart showing the operation of the conference terminal 201 in the transition sequence shown in FIG. 10. First, the session establishing section 113 sends an “INVITE” request to the conference terminal 202 to establish the Call A (S401). Next, the session establishing section 113 receives the “INVITE” request from the conference terminal 203 (S403).

Next, the cut-off message producing section 117 produces a “488” reply in response to this “INVITE” request (S405). The cut-off message producing section 117 describes the reconnection control information instructing that an incoming call from the conference server 211 (sip:192.168.1.1:55060) of the conference terminal 201 be waited, in the Warning header of the “488” reply. For example, the reconnection control information is described as “process=recv;from=“sip:192.168.1.1:55060””. Next, the cut-off message transmitting and receiving section 119 sends the “488” reply which is produced by the cut-off message producing section 117, to the conference terminal 203 (S407).

Next, the cut-off message producing section 117 produces a “BYE” request which is to be sent to the conference terminal 202 engaged in a call (S409). The cut-off message producing section 117 describes the reconnection control information instructing that an incoming call from the conference server 211 (sip:192.168.1.1:55060) of the conference terminal 201 be waited, in the Reason header of the “BYE” request. For example, the reconnection control information is described as “process=recv;from=“sip:192.168.1.1:55060””. Next, the cut-off message transmitting and receiving section 119 sends the “BYE” request which is produced by the cut-off message producing section 117, to the conference terminal 202 (S411).

Next, the session establishing section 113 sends the “INVITE” request in which the addresses of the conference terminals 202, 203 are described in the body as the connection destination list (URI-List), to the incorporated conference server 211 (S413).

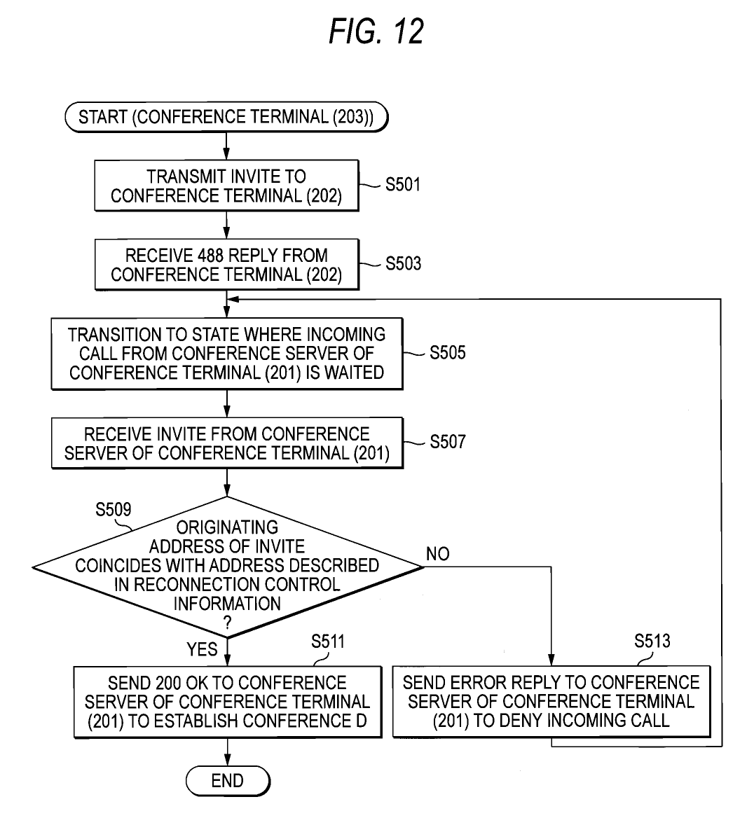

FIG. 12 is a flowchart showing the operation of the conference terminal 203 in the transition sequence shown in FIG. 10. First, the session establishing section 113 sends an “INVITE” request to the conference terminal 201 (S501). Then, the cut-off message transmitting and receiving section 119 receives a “488” reply which is transmitted by the conference terminal 201 in response to this “INVITE” request (S503). The reconnection control information instructing that an incoming call from the conference server 211 (sip:192.168.1.1:55060) of the conference terminal 201 be waited is described in the Warning header of the “488” reply. For example, the reconnection control information is described as “process=recv;from=“sip:192.168.1.1:55060””.

Next, the controlling section 123 sets the own terminal (conference terminal 203) to a state where an incoming call from the conference server 211 of the conference terminal 201 is waited, in accordance with the reconnection control information described in the received “488” reply (S505). Thereafter, the session establishing section 113 receives the “INVITE” request from the conference server 211 of the conference terminal 201 (S507). The controlling section 123 determines whether or not the originating address of the “INVITE” request coincides with the address described in the reconnection control information of the “488” reply which is received in step S503 (S509). The controlling section 123 determines the originating address of the “INVITE” request while referring the From header or the like of the “INVITE” request.

If these addresses coincide with each other, the session establishing section 113 sends a “200 OK” reply to the conference server 211 of the conference terminal 201 to establish “Conference D” (S511). If these addresses do not coincide with each other, the session establishing section 113 performs the following process. The session establishing section 113 sends an error reply (03 Forbidden or the like) in response to the “INVITE” request which is received in step S507, to the conference server 211 of the conference terminal 201 to deny an incoming call (S513). The session establishing section 113 again sets the own terminal to the incoming call waiting state. In step S513, the session establishing section 113 may not send the error reply, and may ignore the “INVITE” request.

In the foregoing description, it has been described that the controlling section 123 determines in step S509 whether or not the originating address of the “INVITE” request coincides with the address described in the reconnection control information of the “488” reply which is received in advance of receiving it. However, the controlling section 123 of the conference terminal 203 may not perform the determination. Namely, the controlling section 123 of the conference terminal 203 may not have the function of referring the reconnection control information described in the “488” reply. In this case, step S513 is not performed. However, there is a case where the session establishing section 113 of the conference terminal 203 receives an “INVITE” request from a conference terminal or a conference server other than the conference server 211 of the conference terminal 201. In this case, the session establishing section 113 of the conference terminal 203 sends a “200 OK” reply in response to the “INVITE” request to this conference terminal or conference server, and establishes a session.

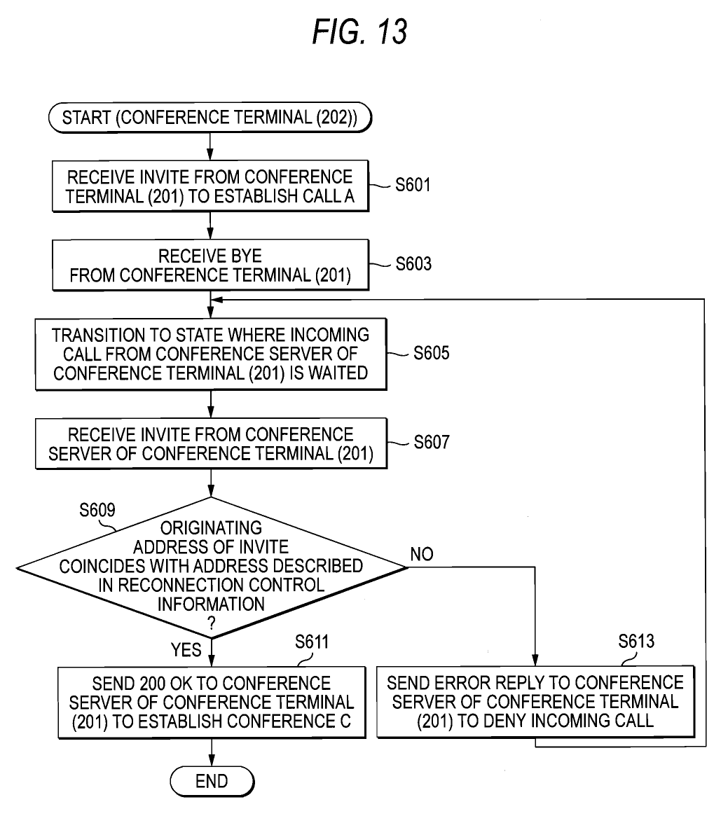

FIG. 13 is a flowchart showing the operation of the conference terminal 202 in the transition sequence shown in FIG. 10. First, the session establishing section 113 receives the “INVITE” request from the conference terminal 201 to establish “Call A” (S601). Next, the cut-off message transmitting and receiving section 119 receives a “BYE” request from the conference terminal 201 (S603). In the Reason header of the “BYE” request, reconnection control information instructing that an incoming call from the conference server 211 (sip:192.168.1.1:55060) of the conference terminal 201 be waited is described. For example, the reconnection control information is described as “process=recv;from=“sip:192.168.1.1:55060””.

Next, the session establishing section 113 sets the own terminal (conference terminal 202) to a state where an incoming call from the conference server 211 of the conference terminal 201 is waited, in accordance with the reconnection control information described in the “BYE” request which is received in step S603 (S605). Thereafter, the session establishing section 113 receives the “INVITE” request from the conference server 211 of the conference terminal 201 (S607). The controlling section 123 determines whether or not the originating address of the “INVITE” request coincides with the address described in the reconnection control information of the “BYE” request which is received in step S603 (S609). The controlling section 123 determines the originating address of the “INVITE” request while referring the From header or the like of the “INVITE” request.

If these addresses coincide with each other, the session establishing section 113 sends a “200 OK” reply to the conference server 211 of the conference terminal 201 to establish “Conference C” (S611). If these addresses do not coincide with each other, the session establishing section 113 performs the following process. The session establishing section 113 sends an error reply (03 Forbidden or the like) in response to the “INVITE” request which is received in step S607, to the conference server 211 of the conference terminal 201 to deny an incoming call (S613). The session establishing section 113 again sets the own terminal to the incoming call waiting state. In step S613, the session establishing section 113 may not send the error reply, and may ignore the “INVITE” request.

In the foregoing description, it has been described that the controlling section 123 determines in step S609 whether or not the originating address of the “INVITE” request coincides with the address described in the reconnection control information of the “BYE” request which is received in advance of receiving it. However, the controlling section 123 of the conference terminal 202 may not perform the determination. Namely, the controlling section 123 of the conference terminal 202 may not have the function of referring the reconnection control information described in the “BYE” request. In this case, step S613 is not performed. However, there is a case where the session establishing section 113 of the conference terminal 202 receives an “INVITE” request from a conference terminal or a conference server other than the conference server 211 of the conference terminal 201. In this case, the session establishing section 113 of the conference terminal 202 sends a “200 OK” reply in response to the “INVITE” request to this conference terminal or conference server, and establishes a session.

In the second embodiment, as described above, the cut-off message producing section 117 of the conference terminal 201 describes instructions related to an operation which is to be performed by each conference terminal, and the address of the incoming destination, as reconnection control information in the “488” reply and the “BYE” request. Moreover, the session establishing section 113 of the conference terminal 201 describes the addresses of the conference terminals 202, 203 as reconnection control information in the “INVITE” request which is to be sent to the incorporated conference server 211. A conference terminal or conference server which receives the request or the reply performs the operation instructed by the reconnection control information, thereby realizing a transition service from a two-party call to a three-party call.

In the embodiment, as described above, only a basic method of the SIP defined in RFC 3261 or the like is used in order to realize a transition service from a two-party call to a three-party call. Therefore, a conference terminal which corresponds to the basic method of the SIP can easily realize the transition service without performing a complicated process. Namely, even a conference terminal which does not correspond to an extension method, or that which uses unique messages can realize the transition service without losing connectivity, as far as it corresponds to the basic method of the SIP. In the embodiment, moreover, man-hours for developing the transition service can be reduced. Furthermore, the number of messages to be transmitted or received is reduced, and hence the time required for executing the service can be shortened.

The SIP is a protocol in which an incomprehensible header is ignored. Therefore, a terminal which does not refer the reconnection control information described in the Reason header of a “BYE” request or Warning header of a “488” reply that is received from another conference terminal or conference server does nothing but ignore these headers. In the case where the conference terminals 202, 203 are terminals which ignore these information, the headers are ignored. However, the conference terminal 202 ends the session in accordance with the “BYE” request to enter the incoming call waiting state, and therefore the transition service can be realized.

### Third Embodiment

In a third embodiment, an example of a transition service from a three-party call to a two-party call which is realized by transmitting and receiving a request or reply corresponding to a basic method of the SIP and containing reconnection control information will be described.

The system of the embodiment is similar to the video conference system shown in FIG. 7 of the second embodiment. Moreover, the conference terminals included in the video conference system of the embodiment are similar to those shown in FIG. 8 of the second embodiment. In the video conference system shown in FIG. 8, a transition from a three-party call between the conference terminals 201 to 203 to a two-party call between the conference terminals 202, 203 is performed in the following procedure. In a three-party call, similarly with the second embodiment, the conference server 211 of the conference terminal 201 is used.

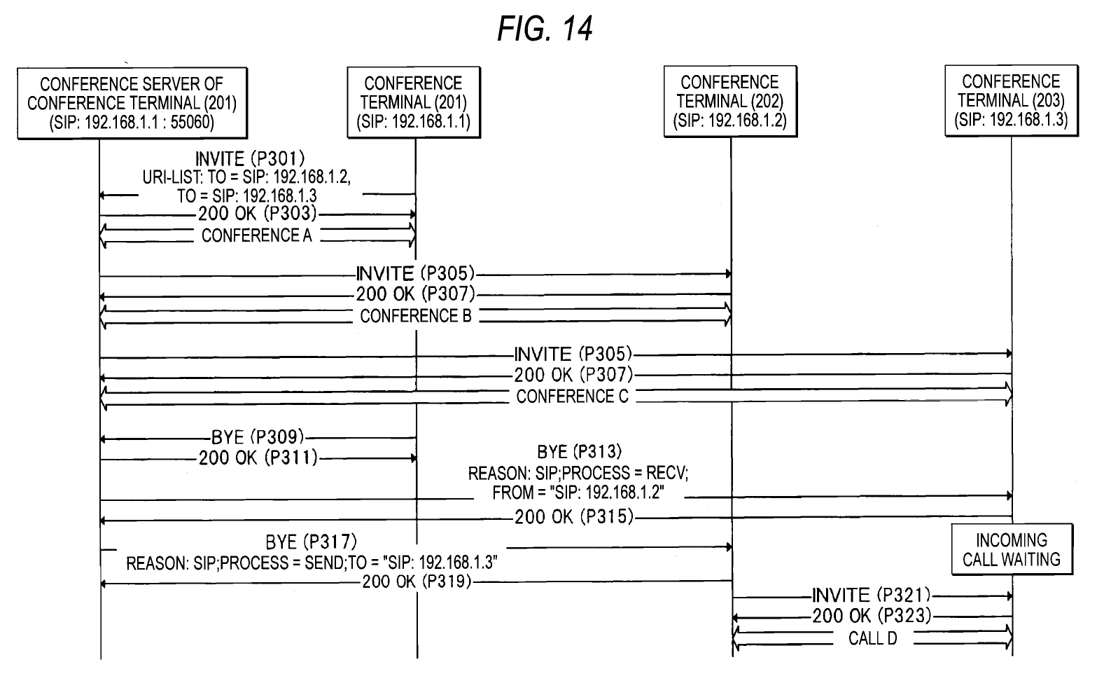

FIG. 14 is a view showing an example of a transition sequence from a three-party call to a two-party call in the video conference system of the third embodiment. In FIG. 14, the illustration of “ACK” is omitted. First, the conference terminal 201 sends an “INVITE” request to the incorporated conference server 211 (sip:192.168.1.1:55060) (P301). The addresses of the conference terminals 202, 203 are described in the body of this “INVITE” request, as a connection destination list (URI-List). The session establishing section 221 of the conference server 211 of the conference terminal 201 sends a “200 OK” reply in response to this “INVITE” request, to the conference terminal 201 (P303). As a result, session “Conference A” is established between the conference server 211 and the conference terminal 201.

Next, the session establishing section 221 of the conference server 211 of the conference terminal 201 sends an “INVITE” request to each of the conference terminals 202, 203 (P205). The conference terminals 202, 203 send a “200 OK” replay in response to this “INVITE” request, to the conference server 211 of the conference terminal 201 (P307). As a result, session “Conference B” is established between the conference server 211 and the conference terminal 202, and session “Conference C” is established between the conference server 211 and the conference terminal 203, so that a three-party call between the conference terminals 201 to 203 is established.

Thereafter, the conference terminal 201 sends a “BYE” request to the incorporated conference server 211 (P309) and leaves the conference. The conference server 211 sends a “200 OK” replay in response to this “BYE” request, to the conference terminal 201 (P311). Furthermore, the conference server 211 sends a “BYE” request to the conference terminal 203 (P313). In the Reason header of the “BYE” request, reconnection control information instructing that an incoming call from the conference terminal 202 (sip:192.168.1.2) be waited is described. For example, the reconnection control information is described as “process=recv;from=“sip:192.168.1.2””. The conference terminal 203 sends a “200 OK” reply in response to this “BYE” request, to the conference server 211 of the conference terminal 201 (P315). Thereafter, the conference terminal 203 transitions into the idle state, and enters a state where an incoming call from the conference terminal 202 is waited.

Next, the conference server 211 sends a “BYE” request to the conference terminal 202 (P317). In the Reason header of the “BYE” request, reconnection control information instructing that an outgoing call to the conference terminal 203 (sip:192.168.1.3) be made is described. For example, the reconnection control information is described as “process=send;to=“sip:192.168.1.3””. The conference terminal 202 sends a “200 OK” reply in response to this “BYE” request, to the conference server 211 of the conference terminal 201 (P319).

In accordance with the reconnection control information described in the Reason header of the “BYE” request sent from the conference server 211 of the conference terminal 201, the conference terminal 202 sends an “INVITE” request to the conference terminal 203 (P321). The conference terminal 203 sends a “200 OK” reply in response to this “INVITE” request, to the conference terminal 202 (P323). As a result, session “Call D” is established between the conference terminal 202 and the conference terminal 203. In this way, in the case where, during the three-party call between the conference terminals 201 to 203, the conference terminal 201 leaves the call, a service in which a transition to a two-party call between the conference terminals 202, 203 is made is realized.

In the third embodiment, as described above, the cut-off message producing section 223 of the conference terminal 201 describes instructions of an operation (outgoing or incoming call) which is to be performed by each conference terminal, and the address of the outgoing or incoming destination, as reconnection control information in the “BYE” request. A conference terminal which receives the “BYE” request performs the operation instructed by the reconnection control information, thereby realizing a transition service from a three-party call to a two-party call.

In the embodiment, as described above, only a basic method of the SIP defined in RFC 3261 or the like is used in order to realize a transition service from a three-party call to a two-party call. In the embodiment, if a conference terminal corresponds to the basic method of the SIP, therefore, the conference terminal can easily realize the transition service without performing a complicated process. Namely, even a conference terminal which does not correspond to an extension method, or that which uses unique messages can realize the transition service without losing connectivity, as far as it corresponds to the basic method of the SIP. In the embodiment, moreover, man-hours for developing the transition service can be reduced. In the embodiment, furthermore, the number of messages to be transmitted or received is reduced, and hence the time required for executing the service can be shortened.

The SIP is a protocol in which an incomprehensible header is ignored. Even when the conference terminal 203 is a terminal which does not refer the reconnection control information described in the Reason header of the “BYE” request that is received from the conference server, therefore, the conference terminal 203 does nothing but ignore these headers. However, the conference terminal 203 enters the incoming call waiting state in accordance with the “BYE” request, and therefore the transition service can be realized.

### Fourth Embodiment

In a fourth embodiment, a transition service from a four-party call to a three-party call which is realized by transmitting and receiving a request or reply corresponding to a basic method of the SIP and containing reconnection control information will be described. In the embodiment, the conference server is transitioned in a transition from a four-party call to a three-party call.

The system of the embodiment is similar to the video conference system shown in FIG. 7 of the second embodiment. Moreover, the conference terminals included in the video conference system of the embodiment are similar to those shown in FIG. 8 of the second embodiment. In the video conference system shown in FIG. 8, a transition from a three-party call between the conference terminals 201 to 203 to a two-party call between the conference terminals 202, 203 is performed in the following procedure. In a four-party call, similarly with the second embodiment, the conference server 211 of the conference terminal 201 is used, and, in a three-party call, the conference server 211 of the conference terminal 202 is used.

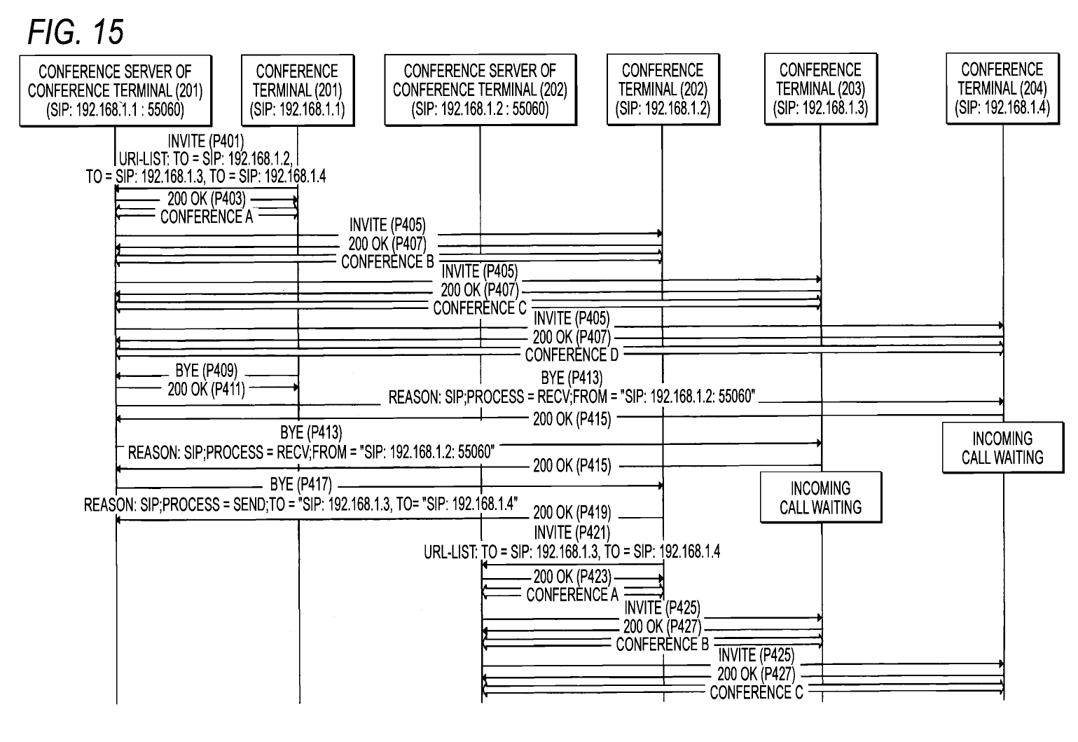

FIG. 15 is a view showing an example of the transition sequence from a four-party call to a three-party call in the video conference system of the fourth embodiment. In FIG. 15, the illustration of “ACK” is omitted. First, the conference terminal 201 sends an “INVITE” request to the incorporated conference server 211 (sip:192.168.1.1:55060) (P401). The addresses of the conference terminals 202 to 204 are described in the body of this “INVITE” request, as a connection destination list (URI-List). The session establishing section 221 of the conference server 211 of the conference terminal 201 sends a “200 OK” reply in response to this “INVITE” request, to the conference terminal 201 (P403). As a result, session “Conference A” is established between the conference server 211 and the conference terminal 201.

Next, the session establishing section 221 of the conference server 211 of the conference terminal 201 sends an “INVITE” request to each of the conference terminals 202 to 204 (P405). The conference terminals 202 to 204 send a “200 OK” replay in response to this “INVITE” request, to the conference server 211 of the conference terminal 201 (P407). As a result, session “Conference B” is established between the conference server 211 and the conference terminal 202, and session “Conference C” is established between the conference server 211 and the conference terminal 203. Furthermore, session “Conference D” is established between the conference server 211 and the conference terminal 204, so that a four-party call between the conference terminal 201 to 204 is established.

Thereafter, the conference terminal 201 sends a “BYE” request to the incorporated conference server 211 (P409) and leaves the conference. Here, the four-party call transitions to a three-party call. Since the conference terminal 201 leaves the conference, however, the used conference server must be transitioned to the conference server of any one of the conference terminals 202 to 204. In the embodiment, an example of a three-party call in which the conference server of the conference terminal 202 is used will be described.

The conference server 211 of the conference terminal 201 sends a “200 OK” replay in response to this “BYE” request, to the conference terminal 201 (P411). Furthermore, the conference server 211 of the conference terminal 201 sends a “BYE” request to the conference terminals 203, 204 (P413). In the Reason header of the “BYE” request, reconnection control information instructing that an incoming call from the conference server 211 (sip:192.168.1.2:55060) of the conference terminal 202 be waited is described. For example, the reconnection control information is described as “process=recv;from=“sip:192.168.1.2:55060””. The conference terminals 203, 204 send a “200 OK” reply in response to this “BYE” request, to the conference server 211 of the conference terminal 201 (P415). Thereafter, the conference terminals 203, 204 transition into the idle state, and enter a state where an incoming call from the conference server 211 of the conference terminal 202 is waited.

Next, the conference server 211 of the conference terminal 201 sends a “BYE” request to the conference terminal 202 (P417). In the Reason header of the “BYE” request, reconnection control information instructing that outgoing calls to the conference terminal 203 (sip:192.168.1.3) and the conference terminal 204 (sip:192.168.1.4) be made is described. For example, the reconnection control information is described as “process=send;to=“sip:192.168.1.3”;to=“sip:192.168.1.4””. The conference terminal 202 sends a “200 OK” reply in response to this “BYE” request, to the conference server 211 of the conference terminal 201 (P419).

In accordance with the reconnection control information described in the Reason header of the “BYE” request sent from the conference server 211 of the conference terminal 201, the conference terminal 202 sends an “INVITE” request to the incorporated conference server 211 (sip:192.168.1.2:55060) (P421). The addresses of the conference terminals 203, 204 are described in the body of this “INVITE” request, as a connection destination list (URI-List). The session establishing section 221 of the conference server 211 of the conference terminal 202 sends a “200 OK” reply in response to this “INVITE” request, to the conference terminal 202 (P423). As a result, session “Conference A” is established between the conference server 211 of the conference terminal 202 and the conference terminal 202.

Next, the session establishing section 221 of the conference server 211 of the conference terminal 202 sends an “INVITE” request to the conference terminals 203, 204 (P425). The conference terminals 203, 204 send a “200 OK” replay in response to this “INVITE” request, to the conference server 211 of the conference terminal 202 (P427). Therefore, session “Conference B” is established between the conference server 211 of the conference terminal 202 and the conference terminal 203, and session “Conference C” is established between the conference server 211 of the conference terminal 202 and the conference terminal 204, with the result that a three-party call between the conference terminal 202 to 204 is established. In this way, in the case where, during the four-party call between the conference terminals 201 to 204, the conference terminal 201 leaves the call, a service in which a transition to a three-party call between the conference terminals 202 to 204 using the conference server 211 of the conference terminal 202 is realized.

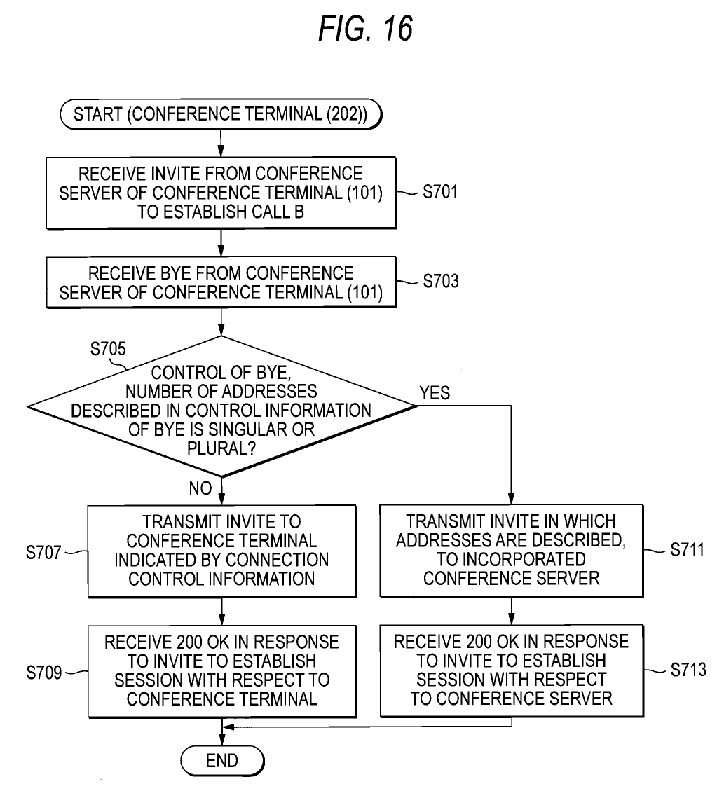

FIG. 16 is a flowchart showing the operation of the conference terminal 202 in the transition sequence in the third embodiment shown in FIG. 14 and the transition sequence in the fourth embodiment shown in FIG. 15. First, the session establishing section 113 receives the “INVITE” request from the conference server 211 of the conference terminal 201 to establish the conference B (S701). Then, the cut-off message transmitting and receiving section 119 receives a “BYE” request from the conference server 211 of the conference terminal 201 (S703). The controlling section 123 determines whether the number of addresses described in reconnection control information of the “BYE” request is singular or plural (S705).

If the address number is a singular number, as shown in procedure P321 of FIG. 14 which has been described in the third embodiment, the session establishing section 113 sends an “INVITE” request to a conference terminal which is indicated by the reconnection control information of the “BYE” request (S707). Thereafter, the session establishing section 113 receives a “200 OK” reply in response to the “INVITE” request to establish a session (S709).

By contrast, if the address number is a plural number, as shown in procedure P421 of FIG. 15 which has been described in the fourth embodiment, the session establishing section 113 sends an “INVITE” request to the incorporated conference server 211 (S711). The addresses of the conference terminals which are indicated by the reconnection control information of the “BYE” request are described in the body of this (INVITE) request, as a connection destination list (URI-List). Next, the session establishing section 113 receives a “200 OK” reply in response to the (INVITE) request from the incorporated conference server 211, to establish a session with respect to the conference server 211 (S713).

In the fourth embodiment, as described above, the cut-off message producing section 223 of the conference terminal 201 describes instructions of an operation (outgoing or incoming call) which is to be performed by each conference terminal, and the address of the outgoing or incoming destination, as reconnection control information in the “BYE” request. A conference terminal which receives the “BYE” request performs the operation instructed by the reconnection control information, thereby realizing a transition service from a four-party call to a three-party call.

In the embodiment, as described above, only a basic method of the SIP defined in RFC 3261 or the like is used in order to realize a transition service from a four-party call to a three-party call. In the embodiment, if a conference terminal corresponds to the basic method of the SIP, therefore, the conference terminal can easily realize the transition service without performing a complicated process. Namely, even a conference terminal which does not correspond to an extension method, or that which uses unique messages can realize the transition service without losing connectivity, as far as it corresponds to the basic method of the SIP. In the embodiment, moreover, man-hours for developing the transition service can be reduced. Furthermore, the number of messages to be transmitted or received is reduced, and hence the time required for executing the service can be shortened.

In the conventional video conference system, in the case where, during a call using the incorporated conference server 910 of the video conference terminal 901, the video conference terminal 901 is to leave the conference, the conference must be once ended in order to transition the conference server. In the transition service in the fourth embodiment, even in the case where, during a four-party call, a conference terminal in which the incorporated conference server is used is to leave, however, it is not necessary to once end the conference. Although, in the fourth embodiment, the transition service from a four-party call to a three-party call has been exemplarily described, the embodiment can be similarly applied to, for example, a transition service from a five-party call to a four-party call and the like.

The SIP is a protocol in which an incomprehensible header is ignored. Even when the conference terminals 203, 204 are terminals which do not refer the reconnection control information described in the Reason header of the “BYE” request that is received from the conference server, therefore, the conference terminals 203, 204 do nothing but ignore these headers. However, the conference terminals 203, 204 enter the incoming call waiting state in accordance with the “BYE” request, and therefore the transition service can be realized.

In the second to fourth embodiments, the configuration where each of the conference terminals 201 to 204 incorporates the conference server 211 has been exemplarily described. However, the conference server 211 may be configured separately from the conference terminals.

Although the invention has been described in detail and with reference to the specific embodiments, it is obvious to those skilled in the art that various changes and modifications can be made without departing from the spirit and scope of the invention.

The application is based on Japanese Patent Application (No. 2009-155291) filed Jun. 30, 2009, and its disclosure is incorporated herein by reference.

### INDUSTRIAL APPLICABILITY

The communication apparatus and communication system of the invention are useful as an audio conference terminal and its system, and a video conference terminal and its system, and the like.

### DESCRIPTION OF REFERENCE NUMERALS AND SIGNS

100 network

101 to 104, 201 to 204 conference terminal

111 communicating section

113 session establishing section

115 session holding section

117 cut-off message producing section

119 cut-off message transmitting and receiving section

121 media data transmitting and receiving section

123 controlling section

125 video/audio inputting/outputting section

127 input interface section

211 conference server

221 session establishing section

223 cut-off message producing section

225 cut-off message transmitting and receiving section

227 controlling section

1. A communication apparatus which controls a session with respect to at least one other communication apparatus by using a basic method or a reply of a call control protocol, the communication apparatus comprising:
a message receiving section that receives a message which is transmitted from the other communication apparatus, and the message in which reconnection control information related to an operation after an end of the session is described in the basic method or the reply; and
a first controlling section that performs a reconnection control based on the reconnection control information contained in the message.

2. The communication apparatus according to claim 1, wherein the reconnection control information is information instructing to maintain an idle state until a session start request is issued from a designated communication apparatus.

3. The communication apparatus according to claim 1, wherein the reconnection control information is information instructing a designated communication apparatus to issue a session start request.

4. A communication apparatus which controls a session with respect to at least one other communication apparatus by using a basic method or a reply of a call control protocol, the communication apparatus comprising:
a first message producing section that produces a message in which reconnection control information related to an operation after an end of the session is described in the basic method or the reply; and
a message transmitting section that transmits the message produced by the first message producing section, to the other communication apparatus.

5. The communication apparatus according to claim 4, wherein the reconnection control information is information instructing to maintain an idle state until a session start request is issued from a designated communication apparatus.

6. The communication apparatus according to claim 4, wherein the reconnection control information is information instructing a designated communication apparatus to issue a session start request.

7.-8. (canceled)

9. The communication apparatus according to claim 1, further comprising:
a conference server section that controls a mutual session among three or more communication apparatuses,
wherein the conference server section includes:
a second message producing section which produces a message in which reconnection control information related to an operation after an end of the session is described in the basic method;
a second controlling section which performs a reconnection control based on the reconnection control information contained in the message which is sent from the other communication apparatus; and
a transmitting and receiving section which transmits the message produced by the second message producing section, to a plurality of other communication apparatuses, and which receives a message that is sent from the other communication apparatus.

10. (canceled)

11. The communication apparatus according to claim 1, wherein a session start request or a session end request is contained in the basic method.

12. The communication apparatus according to claim 1, wherein the call control protocol is an SIP (Session Initiation Protocol).

13. The communication apparatus according to claim 12, wherein the session start request is “INVITE” defined in the SIP.

14. The communication apparatus according to claim 12, wherein the session end request is “BYE” defined in the SIP.

15.-17. (canceled)

18. A session control method of controlling a session among a plurality of communication apparatuses by using a basic method or a reply of a call control protocol, wherein each of the plurality of communication apparatuses including:
a message producing section which produces a message in which first reconnection control information instructing to maintain an idle state until a session start request is issued from a designated communication apparatus, or second reconnection control information instructing a designated communication apparatus to issue a session start request is described in the basic method or the reply; and
a message transmitting and receiving section which transmits the message produced by the message producing section, to another communication apparatus, and which receives a message which is sent from the other communication apparatus; and
wherein the each of the plurality of communication apparatuses performs a reconnection control based on the reconnection control information contained in the message which is sent from the other communication apparatus.

19. The communication apparatus according to claim 4, further comprising:
a conference server section that controls a mutual session among three or more communication apparatuses,
wherein the conference server section includes:
a second message producing section which produces a message in which reconnection control information related to an operation after an end of the session is described in the basic method;
a second controlling section which performs a reconnection control based on the reconnection control information contained in the message which is sent from the other communication apparatus; and
a transmitting and receiving section which transmits the message produced by the second message producing section, to a plurality of other communication apparatuses, and which receives a message that is sent from the other communication apparatus.

20. The communication apparatus according to claim 4, wherein a session start request or a session end request is contained in the basic method.

21. The communication apparatus according to claim 4, wherein the call control protocol is an SIP (Session Initiation Protocol).
